(19) United States
(12) Patent Application Publication
(10) Pub. No.: US 2024/0193353 A1
(43) Pub. Date: Jun. 13, 2024

(54) TEXT SEGMENTATION METHOD, COMPUTER DEVICE AND STORAGE MEDIUM

(71) Applicant: MaShang Consumer Finance Co., Ltd., Chongqing (CN)

(72) Inventors: Changlin Li, Chongqing (CN); Bing Xiao, Chongqing (CN); Lei Cao, Chongqing (CN); Qishuai Luo, Chongqing (CN)

(21) Appl. No.: 18/585,952

(22) Filed: Feb. 23, 2024

Related U.S. Application Data
(63) Continuation-in-part of application No. PCT/CN2023/100021, filed on Jun. 13, 2023.

(30) Foreign Application Priority Data
Jul. 7, 2022 (CN) 202210795690.9

(51) Int. Cl. G06F 40/166

(52) U.S. Cl. CPC G06F 40/166

(57) ABSTRACT

An embodiment of the present application provides a text segmentation method, a computer device and a storage medium, among them, the method includes: obtaining a text to be segmented, preprocessing the text and determining a processed text; calculating a confidence of a segment point between two adjacent characters in the processed text, determining a position of the segment point in the processed text based on the confidence; and segmenting the text according to the position. Through this embodiment, the problem of low efficiency of word segmentation in existing word segmentation method can be solved.

### CROSS REFERENCE

This application claims priority to a Chinese patent application filed with the China National Intellectual Property Administration on Jul. 7, 2022, with application number 202210795690.9 and titled “TEXT SEGMENTATION METHOD, DEVICE, COMPUTER DEVICE AND STORAGE MEDIUM”. The entire content of this application is incorporated in this application by reference.

### FIELD

The present application relates to the field of natural language processing, and in particular, to a text segmentation method, a computer device and a storage medium.

### BACKGROUND

Word segmentation of a text is an important step in a process of a natural language processing. A segmentation result with a high-accuracy is a prerequisite required for a process of a deep natural language processing, such as a personalized recommendation, a sentiment analysis, a topic classification, a public opinion analysis, etc.

### BRIEF DESCRIPTION OF THE DRAWINGS

In order to explain the embodiments of the present application or the technical solutions in the prior art more clearly, the drawings needed to be used in the description of the embodiments or the prior art will be briefly introduced below. Obviously, the drawings in the following description are only some of the embodiments described in one or more of the present application. For those of ordinary skill in the art, other drawings can be obtained based on these drawings without exerting any creative effort.

FIG. 1 is a schematic flowchart of a text segmentation method provided by an embodiment of the present application;

FIG. 2 is a schematic flowchart of detecting whether there is a segment point between two adjacent characters provided by an embodiment of the present application;

FIG. 3 is a schematic flowchart of detecting whether there is a segment point between two adjacent characters provided by another embodiment of the present application;

FIG. 4 is a schematic structural diagram of a text segmentation device provided by an embodiment of the present application;

FIG. 5 is a schematic structural diagram of a computer device provided by an embodiment of the present application.

### DESCRIPTION

In order to enable those skilled in the art to better understand one or more technical solutions in the present application, the technical solutions in the embodiments of the present application will be clearly and completely described below in conjunction with the drawings in the embodiments of the present application. Obviously, the described embodiments are only one or more partial embodiments of the present application, rather than all embodiments. Based on one or more embodiments of this application, all other embodiments obtained by those of ordinary skill in the art without creative efforts should fall within the protection scope of this application.

It should be noted that, without conflict, one or more embodiments and features in the embodiments of the present application can be combined with each other. The embodiments of the present application will be described in detail below with reference to the accompanying drawings and embodiments.

At present, a word segmentation can be performed based on a statistical method. The main principle of the method is to calculate statistical features by using a large amount of experimental corpus for determining words in a text. For example, the statistical features may be a word frequency, a word formation probability, a left branch entropy and a right branch entropy, an accessor variety, etc. However, in this word segmentation method, on one hand, due to a need to calculate parameters such as the left branch entropy and the right branch entropy, the accessor variety, etc., a calculation process is complicated, which results in a low efficiency of word segmentation. On another hand, there is a limit on a length of a word after word segmentation. Usually, the word after segmentation includes at most four characters, and a word including five or more characters cannot be obtained through segmentation.

In order to solve the problem that the existing word segmentation method has a low efficiency of word segmentation and the length of the word after word segmentation is limited, an embodiment of the present application provides a text segmentation method. The main idea of this method includes: first, obtaining a text to be segmented, preprocessing the text to obtain a processed text, and then performing a segment position identification in the processed text. The segment position identification includes: calculating a first confidence of the segment point between two adjacent characters in the processed text, and/or, calculating a second confidence of the segment point, which does not exist between two adjacent characters in the processed text, and determining the position of the segment point in the processed text according to a calculation result, finally, the text is segmented based on the position. On one hand, in this embodiment, there is no need to calculate complex parameters such as the left branch entropy and the right branch entropy, the accessor variety, etc. during word segmentation, so the efficiency of word segmentation can be improved. On another hand, because this embodiment determines whether there is the segment point between two adjacent characters, there is no limit to the length of the word after word segmentation, so the word of any length can be obtained by word segmentation. Therefore, according to this embodiment, it is possible to solve the problem that the existing word segmentation method has low efficiency of word segmentation and limits the length of the word after word segmentation.

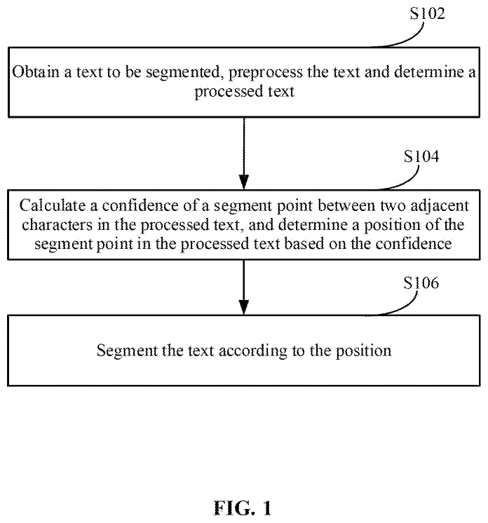

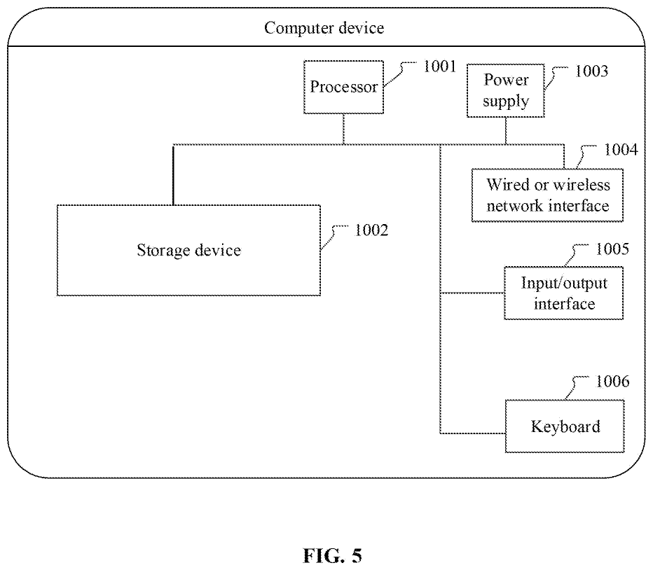

FIG. 1 is a schematic flow chart of a text segmentation method provided by an embodiment of the present application. In one embodiment, the text segmentation method may be applied to a computer device (such as the computer device as shown in FIG. 5). The computer device can specialize in a natural language processing. As shown in FIG. 1, the process includes the following steps:

Step S102, the computer device obtains a text to be segmented, preprocesses the text and determines a processed text.

Step S104, the computer device performs a segment position identification in the processed text. In one embodiment, the segment position identification may include calculating a confidence of a segment point between two adjacent characters in the processed text, and determining a position of the segment point in the processed text based on the confidence.

Step S106, the computer device segments the text based on the position.

In this embodiment, the computer device first obtains the text, preprocesses the text and obtains the processed text, and then performs the segment position identification in the processed text. The segment position identification may include calculating the confidence of the segment point between two adjacent characters in the processed text, and determining the position of the segment point in the processed text based on the confidence. On the one hand, in this embodiment, there is no need to calculate complex parameters such as the left branch entropy and the right branch entropy, the accessor variety during word segmentation. Thus the efficiency of word segmentation can be improved. On the other hand, because this embodiment performs a determination for determining whether there is the segment point between two adjacent characters, and there is no limit to the length of the word after word segmentation, thus words of any length can be obtained by performing a word segmentation. Therefore, according to this embodiment, it is possible to solve the problem that the existing word segmentation method has low efficiency of word segmentation and limits the length of the segmented word.

In one embodiment of the above step S102, the text is obtained. In one embodiment, the text can be obtained from a text collection to be segmented. The text collection to be segmented includes a collection of a large number of sentences, and the text can be any sentence in the text collection to be segmented.

In one embodiment of the above step S102, the text is also pre-processed to obtain the processed text. There are many ways to preprocess the text, such as setting a text format of the text to a default format to facilitate a segmentation of the text, or removing punctuation marks from the text to facilitate the segmentation of the text.

In one embodiment, the text is preprocessed to determine the processed text, specifically: matching a pre-established stopword list with the text and determining a character that is in both of the text and the stopword list, determining a position of the segment point in the text according to the determined character, and determining the text as the processed text, after the position of the segment point has been determined.

In one embodiment, the pre-established stopword list may include, but is not limited to, preset stop phrases, preset stop words, preset punctuation marks, preset numbers, preset special symbols, for example. There is a plurality of stopword lists, which belong to different fields. For example, there are three stopword lists, respectively belong to a financial field, a military field, and a political field. The stopword list that belongs to the same field as the text can be selected to preprocess the text to improve a preprocessing accuracy.

During preprocessing, the pre-established stopword list is matched with the text to determine the character that is in both of the text and the stopword list. Since the determined character is in the stopword list, for example, the determined character is a phrase or a single word or a single number or a single symbol that has been segmented. Therefore, the position of the segment point can be determined in the text based on the determined character. In the text, a position before the determined character and after the determined character can be determined as the positions of segment points. The text that has completed the determination of the positions of segment points can be determined as the processed text.

Before determining the positions of segment points in the text based on the determined character, position symbols can also be inserted into the text. The inserted position symbol represents the position of each character in the text. For example, for the text “ [symbol] ”, the following is obtained after insert position symbols before a first character in the text and after each character in the text:
0 [symbol] 1 [symbol] 2 [symbol] 3 [symbol] 4 [symbol] 5 [symbol] 6 [symbol] 7∘8

After inserting the position symbol, according to the determined characters, the positions of segment points are identified in the text as follows. In response that the determined character is a stop phrase, a position represented by a position symbol before the stop phrase and a position represented by a position symbol after the stop phrase in the text are determined as positions of segment points. In response that the determined character is a stop word, a punctuation mark, a number or a special symbol, a position represented by the position symbol before the determined character and a position represented by the position symbol after the determined character in the text are determined as positions of segment points.

Specifically, because the determined characters are both in the text and in the stopword list, and in the pre-established stopword list, not only stop phrases are recorded, but also stop words, punctuation marks, numbers and special symbols, etc., are recorded, so the determined character may belong one of two situations. In one situation, the determined character is a stop phrase, for example, for the text “ [symbol] ”, in which the determined character is “ [symbol] ”. In another situation, the determined character is a stop word, a punctuation mark, a number or a special symbol. For example, for the text “ [symbol] ”, the determined character is “?”.

In response that the determined character is a stop phrase, in the text, the position represented by the position symbol before the stop phrase and the position represented by the position symbol after the stop phrase are determined as the positions of segment points. For example, for the text “ [symbol] ”, in which the determined character is “ [symbol] ”, then the position represented by the position symbol “5” before “ [symbol] ” and the position represented by the position symbol “7” after “ [symbol] ” are determined as the positions of segment points. Correspondingly, the positions of segment points can be recorded as (5, 7).

When the determined character is the stop word, the punctuation mark, the number or the special symbol, in the text, the position represented by the position symbol before the determined character and the position represented by the position symbol after the determined character are determined as the positions of segment points. For example, for the text “ [symbol] [symbol] ”, in which the determined character is “∘”, then the position represented by the position symbol “7” before “∘” and the position represented by the position symbol “8” after “∘” are determined as the positions of segment points. Correspondingly, the positions of segment points can be recorded as (7, 8).

It can be seen that by matching the pre-established stopword list with the text, the positions of segment points can be initially identified and recorded in the text. By the way of matching the stopword list, the positions of segment points can be preliminarily identified in the text. Positions of segment points caused by some common stop phrases, words or symbols identified preliminarily can improve the efficiency of the segment position identification.

It should be noted that during the preprocessing process of the text, some positions of segment points are determined by matching the stopword list. Correspondingly, in the above step S106, when segmenting the text based on the positions of segment points, the positions of segment points include the position of the segment point obtained during the preprocessing process and the position of the segment point identified in step S104.

Moreover, in this embodiment, after the position of the segment point is determined, the text is determined as the processed text, and the embodiment also includes recording the position of the above-mentioned determined character in the text, so as to skip the determined character when determining the position of the segment point in step S104.

In one embodiment, when the determined character is a stop phrase, the position represented by the position symbol before the stop phrase and the position represented by the position symbol after the stop phrase in the text, are determined as the positions of segment points, and the positions of segment points are recorded as the positions of the determined character in the text, so as to skip the determined character during the process of the segment position identification in step S104. For example, for the text “ [symbol] ”, in which the determined character is “ [symbol] ”, then the position represented by the position symbol “5” before “ [symbol] ” and the position represented by the position symbol “7” after “ [symbol] ” are determined as the positions of segment points, i.e., the positions of the determined character in the text. Correspondingly, the positions of the determined character can be recorded as (5, 7).

When the determined character is a stop word, a punctuation mark, a number or a special symbol, the position represented by the position symbol before the determined character and the position represented by the position symbol after the determined character in the text, are determined as the positions of segment points, and the positions of segment points are recorded as the positions of the determined character in the text, so as to skip the determined character during the process of the segment position identification in step S104. For example, for the text “ [symbol] [symbol] ”, in which the determined character is “∘”, then the position represented by the position symbol “7” before “∘” and the position represented by the position symbol “8” after “∘” are determined as the positions of segment points, for example, the positions of the determined character in the text. Correspondingly, the positions of the determined character can be recorded as (7, 8).

It can be understood that in the above method, based on the determined character, the position of the segment point identified in the text is equivalent to the positions of the determined character in the text. Through the above process of this embodiment, after matching the pre-established stopword list with the text to determine the character that is in both of the text and the stopword list, the determined character is also added into the text. The position in the text is recorded so that the above-mentioned determined character can be skipped during the process of the segment position identification in step S104 and the determined character will not be recognized twice.

In the above step S104, the segment position identification is performed in the processed text. The segment position identification includes calculating the confidence of the segment point between two adjacent characters in the processed text, and determining the position of the segment point in the processed text based on the confidence.

In one embodiment, the calculating of the confidence of the segment point between two adjacent characters in the processed text includes calculating a first confidence of the segment point between two adjacent characters in the processed text.

In one embodiment, the calculating of the confidence of the segment point between two adjacent characters in the processed text includes calculating a second confidence of the segment point, which does not exist between two adjacent characters in the processed text.

In one embodiment, the calculating of the confidence of the segment point between two adjacent characters in the processed text includes: calculating the first confidence of the segment point between two adjacent characters in the processed text; and calculating the second confidence of the segment point, which does not exist between two adjacent characters in the processed text.

Regarding the meaning of two adjacent characters in the processed text, it is described herein. According to the above process, it can be seen that the text that has been identified based on the stopword list is the processed text. Moreover, the character determined based on the stopword list is not deleted from the text. Therefore, the text includes the same character as the processed text. However, since the characters determined by the stopword list are no longer needed to participate in the process of the segment position identification in step S104, in step S104, the two adjacent characters involved in the segment position identification refer to any two adjacent characters in the processed text, excluding the characters determined by the stopword list. In step S104, through the process of the segment position identification, it is identified whether there is the segment point between the two adjacent characters in the processed text.

For example, for the text “ [symbol] ”, the determined character obtained by the stopword list is “ [symbol] ”, and “ [symbol] ” no longer participates in the process of the segment position identification in step S104. Therefore, in step S104, the two adjacent characters involved in the segment position identification refer to any two adjacent characters in the processed text “ [symbol] [symbol] ”, and the adjacent characters do not include “ [symbol] ”. Two adjacent characters can include “ [symbol] ” and “ [symbol] ”. Among them, “ [symbol] ” and “ [symbol] ” are not considered as adjacent characters because there is “ [symbol] ” between them. In step S104, through the process of the segment position identification, it is identified whether there is a segment point between “ [symbol] ” and “ [symbol] ” and whether there is a segment point between “ [symbol] ” and “ [symbol] ”.

The following embodiments describe how to perform the segment position identification in step S104 to skip characters determined by the stopword list.

In one embodiment, in step S104, the computer device calculates the confidence of the segment point between two adjacent characters in the processed text, and determines the position of the segment point in the processed text based on the confidence by:
(a1) Determining a starting position of the processed text as a traversal starting position and executing a first traversal process;
(a2) In response that a position of a segment point is determined, determining the position of the segment point as the traversal starting position and repeating the first traversal process, in response that a recorded position is traversed, traversing from the traversed position until a next recorded position is traversed, and determining the next recorded position as the traversal starting position and repeating the first traversal process.

In action (a1), the starting position of the processed text for example, a position before a first character in the processed text, is determined as the traversal starting position, and the first traversal process is executed. In the first traversal process, each two adjacent characters are traversed from the traversal starting position, and the first confidence of the segment point between each two adjacent characters that have been traversed is calculated, and/or, the second confidence of the segment point, which does not exist between each two adjacent characters that have been traversed is calculated, and based on the calculation result, whether there is the segment point between every two adjacent characters that have been traversed is identified. In one case, according to the calculation result, when it is determined that there is the segment point between two adjacent characters that have been traversed, then the position of the segment point is determined. In another case, the position of the segment point is not determined, but the previously recorded position of the determined character in the text is traversed. In another case, an ending position of the processed text is traversed and the traversal is determined to be end, the ending position is a position after a last character in the processed text.

In an example, for the processed text “0 [symbol] 1 [symbol] 2 [symbol] 3 [symbol] 4 [symbol] 5 [symbol] 6” that has been added with position symbols, where “ [symbol] ” is the determined character, and the corresponding recorded position is (2, 4). For the processed text, traverse starts from position “0”. If it is determined that there is a segment point between “ [symbol] ” and “ [symbol] ”, then it is determined that the position of the segment point is traversed, and the position of the segment point is 1. If it is determined that there is no segment point between “ [symbol] ” and “ [symbol] ”, then continue the traversal and find that the traversal reaches position 2, which is the pre-recorded position of the determined character in the text. If there are no characters predetermined through the stopword list in the sentence “0 [symbol] 1 [symbol] 2 [symbol] 3 [symbol] 4 [symbol] 5 [symbol] 6”, then traverse from position “0” and determine there is no segment point between any two adjacent characters, and traverse directly to the ending position 6 of the processed text.

In action (a2), if the position of the segment point is identified, the position of the segment point is determined as the traversal starting position and the first traversal process is repeated. Referring to the previous example, if there is a segment point between “ [symbol] ” and “ [symbol] ”, the position of the segment point is 1, and position 1 is determined as the traversal starting position, and continues to traverse backwards. A special case needs to be explained here, from position 1, when it is found that the next position is position 2, and there is only one character between position 1 and position 2, then this character is an independent word in a segmentation result. A similar example to this situation is, for the sentence “0 [symbol] 1 [symbol] 2 [symbol] 3 [symbol] 4”, assuming that the position recorded by matching the stopword list is (1, 4), then traverse from position 0, when it is found that position 1 is the recorded position, and there is only one character between position 0 and position 1, then this character is an independent word in the segmentation result. It should be noted that after matching the stopword list, the positions of segment points have been identified and recorded in the text based on the determined characters, so the recorded positions can be determined as positions of segment points to participate in word segmentation.

In action (a2), during the traversal process, if the previously recorded position recorded by matching the stopword list is traversed, then the traversal continues from the traversed position until the next recorded position is traversed, the next recorded position is determined as the traversal starting position and the first traversal process is repeated. Take the sentence “0 [symbol] 1 [symbol] 2 [symbol] 3 [symbol] 4 [symbol] 5 [symbol] 6”as an example, the pre-recorded position is (2, 4), assuming that during the traversal process, it is determined that there is no segment point between “ [symbol] ” and “ [symbol] ”, then continue to traverse and position 2 is traversed, the traversal continues from position 2 until a next position of the pre-recorded position 2, i.e., position 4, is traversed, position 4 is determined as the traversal starting position, and the first traversal process is repeated.

The first traversal process includes: traversing every two adjacent characters from the traversal starting position, calculating the first confidence of the segment point between each two adjacent characters that have been traversed, and/or calculating the second confidence of the segment point, which does not exist between every two adjacent characters that have been traversed, determining whether there is the segment point between every two adjacent characters traversed according to the calculation result, until the position of the segment point is identified or the recorded position is traversed, or the ending position of the processed text is traversed.

In this embodiment, when recording the position of the character matched through the stopword list, the position of the character can be recorded in a specific format, such as a format (starting position, ending position), so when the recorded position is traversed, and the recorded position is the starting position of the character that is matched, continue to traverse backward, until the next recorded position that is traversed is the ending position of the character that is matched. Therefore, the next recorded position that is traversed is determined as the traversal starting position and the first traversal process is repeated.

It can be seen that in this embodiment, through the above actions (a1) and (a2), the pre-recorded positions can be skipped through a loop traversal, so as to avoid a secondary identification of the pre-matched characters.

In another embodiment, in step S104, calculating the confidence of the segment point between two adjacent characters in the processed text, and determining the position of the segment point in the processed text based on the confidence, specifically includes:
(b1) Segmenting the processed text according to the starting position, the ending position and the recorded position of the processed text, and determining a plurality of sub-texts;
(b2) For each sub-text, determining the starting position of the sub-text as a traversal starting position and performing a second traversal process; the second traversal process includes: traversing every two adjacent characters from the traversal starting position, and calculating the first confidence of the segment point between every two adjacent characters that have been traversed, and/or, calculating the second confidence of the segment point, which does not exist between every two adjacent characters that have been traversed, determining whether there is the segment point between each two adjacent characters that have been traversed according to the calculation result, until the position of the segment point is identified or the ending position of the sub-text is traversed;
(b3) If the position of the segment point is determined, determining the position of the segment point as the traversal starting position and repeating the second traversal process.

In action (b1), the processed text is segmented according to the starting position, the ending position and the recorded position of the processed text to obtain the plurality of sub-texts. For example, for the sentence “0 [symbol] 1 [symbol] 2 [symbol] 3 [symbol] 4 [symbol] 5 [symbol] 6”, in which “ [symbol] ” is the predetermined character, and the corresponding recorded position is (2, 4), then the starting position and the ending position of each sub-text can be determined according to the starting position, the ending position and the recorded position of the processed text, and obtain the plurality of sub-texts based on the starting position and the ending position of each sub-text, among them, in each sub-text obtained through segmentation, no predetermined character is included. For example, the plurality of sub-texts are obtained through segmentation, namely “0 [symbol] 1 [symbol] 2” and “4 [symbol] 5 [symbol] 6”.

In action (b2), in each sub-text, the starting position of the sub-text is determined as the traversal starting position and the second traversal process is performed. In another case, if the position of the segment point is not determined, but the ending position of the sub-text is reached, the end of the traversal is determined, and the ending position is the position after the last character in the sub-text.

In action (b3), if the position of the segment point is determined, the position of the segment point is determined as the traversal starting position and the second traversal process is repeated.

Taking the sub-text “0 [symbol] 1 [symbol] 2” as an example, start traversing from position 0, determine that there is no segment point between “ [symbol] ” and “ [symbol] ”, traverse to position 2 and the end of the traversal is determined. Take the sub-text “4 [symbol] 5 [symbol] 6” as an example, start traversing from position 4, if it determines that there is a segment point between “ [symbol] ” and “ [symbol] ”, then the position of the segment point 5 is recorded, and start from position 5 and traverse to position 6, and determine that the traversal is complete.

It can be seen that through this embodiment, the processed text can be segmented according to the starting position, the ending position and the recorded position of the processed text, to obtain the plurality of sub-texts, and within each sub-text, the pre-recorded positions are skipped through loop traversal to avoid the secondary identification of pre-matched characters.

In another embodiment, within each sub-text, there is no need to perform the loop traversal, and the first confidence of the segment point between every two adjacent characters in the sub-text can be calculated, and/or, the second confidence of the segment point, which does not exist between every two adjacent characters in the sub-text can be calculated, and based on the calculation result, the position of the segment point is identified within the sub-text.

The second traversal process includes: traversing every two adjacent characters from the traversal starting position, calculating the first confidence of the segment point between every two adjacent characters that have been traversed in the sub-text, and/or, calculating the second confidence of the segment point, which does not exist between every two adjacent characters that have been traversed in the sub-text, and determining whether there is the segment point between every two adjacent characters that have been traversed based on the calculation result. In one case, according to the calculation result, when it is determined that there is the segment point between each two adjacent characters that have been traversed, and then the position of the segment point is determined.

The above action (a1) and the above action (b2) both involve the process of calculating the first confidence and/or the second confidence, and determining whether there is the segment point between two adjacent characters based on the calculation result. In this process and in step S104, the calculating of the confidence of the segment point between two adjacent characters in the processed text, and the determining of the position of the segment point in the processed text based on the confidence are similar. Next, the process of calculating the confidence of the segment point between two adjacent characters in the processed text, and determining the position of the segment point in the processed text according to the confidence in step S104, is introduced below. For the specific implementation details of the above action (a1) and the above action (b2), please refer to the following description.

In step S104, calculating the confidence of the segment point between two adjacent characters in the processed text, and determining the position of the segment point in the processed text according to the confidence, specifically includes:
(c1) In the processed text, calculating the first confidence of the segment point between two adjacent characters; if the first confidence is less than or equal to a first preset threshold, determining that there is no segment point between the two adjacent characters; if the first confidence is greater than the first preset threshold, then calculating the second confidence of the segment point, which does not exist between the two adjacent characters; if the second confidence is less than a second preset threshold, then it is determined that there is the segment point between the two adjacent characters, if the second confidence is greater than or equal to the second preset threshold, it is determined that there is no segment point between the two adjacent characters.

Or, (c2), in the processed text, calculating the second confidence of the segment point, which does not exist between two adjacent characters; if the second confidence is greater than or equal to the second preset threshold, determining that there is no segment point between two adjacent characters. If the second confidence is less than the second preset threshold, then the first confidence of the segment point between two adjacent characters is calculated; if the first confidence is greater than the second preset threshold, it is determined that there is the segment point between two adjacent characters. If the first confidence is less than or equal to the first preset threshold, it is determined that there is no segment point between two adjacent characters.

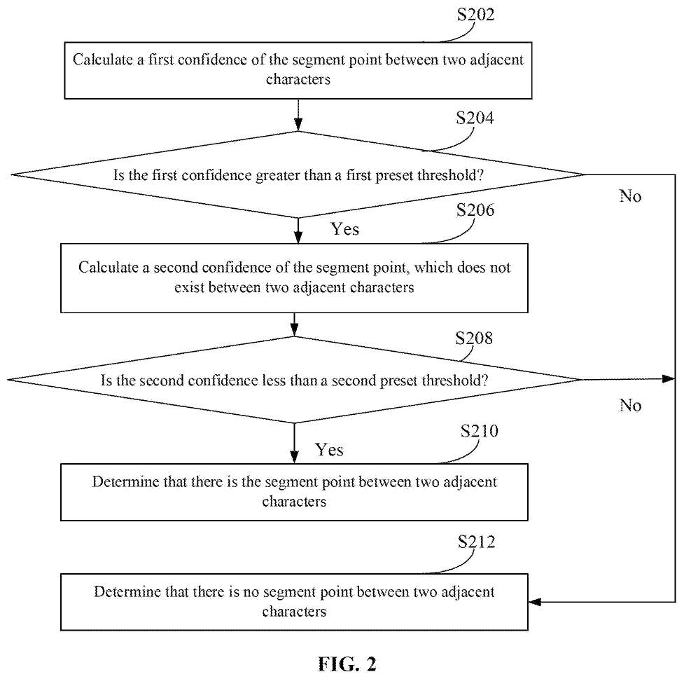

FIG. 2 is a schematic flowchart of detecting whether there is the segment point between two adjacent characters provided by an embodiment of the present application. As shown in FIG. 2, the process includes:

Step S202, the computer device calculates the first confidence of the segment point between two adjacent characters.

Step S204, the computer device determines whether the first confidence is greater than the first preset threshold.

In response that the first confidence is greater than the first preset threshold, step S206 is executed. In response that the first confidence is less than or equal to the first preset threshold, step S212 is executed.

Step S206, the computer device calculates the second confidence of the segment point, which does not exist between two adjacent characters.

Step S208, the computer device determines whether the second confidence is less than the second preset threshold;

In response that the second confidence is less than the second preset threshold, step S210 is executed; in response that the second confidence is greater than or equal to the second preset threshold, step S212 is executed.

Step S210, the computer device determines that there is the segment point between two adjacent characters.

Step S212, the computer device determines that there is no segment point between two adjacent characters.

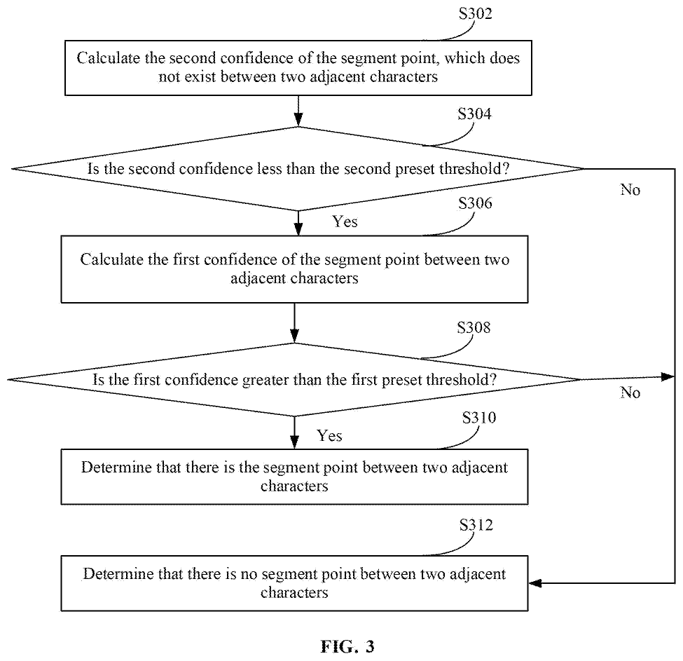

FIG. 3 is a schematic flowchart of detecting whether there is the segment point between two adjacent characters provided by another embodiment of the present application. As shown in FIG. 3, the process includes:

Step S302, the computer device calculates the second confidence of the segment point, which does not exist between two adjacent characters.

Step S304, the computer device determines whether the second confidence is less than the second preset threshold.

In response that the second confidence is less than the second preset threshold, step S306 is executed; in response that the second confidence is greater than or equal to the second preset threshold, step S312 is executed.

Step S306, the computer device calculates the first confidence of the segment point between two adjacent characters.

Step S308, the computer device determines whether the first confidence is greater than the first preset threshold.

In response that the first confidence is greater than the first preset threshold, step S310 is executed; in response that the first confidence is less than or equal to the first preset threshold, step S312 is executed.

Step S310, the computer device determines that there is the segment point between two adjacent characters.

Step S312, the computer device determines that there is no segment point between two adjacent characters.

It can be seen from the processes of FIG. 2 and FIG. 3, that the first preset threshold is set for the first confidence, and the second preset threshold is set for the second confidence. The first preset threshold and the second preset threshold can be set as needed. As can be seen from the processes in FIG. 2 and FIG. 3, we can first calculate the first confidence of the segment point between two adjacent characters, and also calculate the second confidence of the segment point, which does not exist between two adjacent characters. In the case where there is no segment point between two adjacent characters, it is only necessary to calculate one of the first confidence and the second confidence. In the case where there is the segment point between two adjacent characters, both the first confidence and the second confidence need to be calculated. Therefore, in this embodiment, it is essentially based on the first confidence of the segment point between two adjacent characters, and/or the second confidence of the segment point not between every two adjacent characters, to detect whether there is the segment point between two adjacent characters.

In one embodiment, for two adjacent characters in the processed text, calculating the first confidence of the segment point between the two adjacent characters, specifically includes:
(d1) Obtaining a first number of occurrences of each of the two adjacent characters occurs in a preset text library, and obtaining a second number of occurrences of the two adjacent characters occur adjacently in the preset text library.
(d2) Calculating the first confidence of the segment point between two adjacent characters based on the first number of occurrences corresponding to each character of the two adjacent characters and the second number of occurrences.

According to the above, the processed text comes from the text, and the text can come from the text collection to be segmented. Therefore, in this step, the preset text library can be the text collection to be segmented. Of course, the preset text library can also be other text library pre-established including large amounts of text.

In step (d1), the first number of occurrences of each of the two adjacent characters occurs in the preset text library is obtained. Furthermore, the second number of occurrences of two adjacent characters occur adjacently in the preset text library is obtained. Among them, when obtaining the first number of occurrences, it includes the situation where one of the two adjacent characters appears adjacent to the other of the two adjacent characters. That is to say, the first number of occurrences includes the second number of occurrences. It can be understood that the second number of occurrences is actually the number of occurrences of two adjacent characters appearing as one phrase in the preset text library.

In step (d2), based on the first number of occurrences and the second number of occurrences corresponding to each of the two adjacent characters, the first confidence of the segment point between the two adjacent characters is calculated. In one embodiment, step (d2) specifically includes:
(d21) Obtaining a product by multiplying the first number of occurrences corresponding to each character of two adjacent characters, and calculating a ratio of the product to the second number of occurrences.
(d22) Determining the first confidence of the segment point between two adjacent characters based on the ratio.

In step (d21), the first number of occurrences corresponding to each of the two adjacent characters are multiplied to obtain a product. Furthermore, the product is divided by the second number of occurrences of two adjacent characters as one phrase in the preset text library to obtain a ratio. In step (d22), based on the ratio, the first confidence of the segment point between two adjacent characters is determined.

In one example, the processed text obtained is “ [symbol] ”. In this step, starting from “ [symbol] ”, the first confidence of the segment point between “ [symbol] ” and “ [symbol] ” is calculated. The calculation process specifically includes:

Obtain a number of occurrences of “ [symbol] ” in the text collection to be segmented as the first number of occurrences, and obtain a number of occurrences of “ [symbol] ” in the text collection to be segmented as the first number of occurrences. When calculating the first number of occurrences, consider a situation that “ [symbol] ” and “ [symbol] ” occur adjacently. And, obtain a number of occurrences of “ [symbol] ” as a whole phrase in the text collection to be segmented as the second number of occurrences.

Use formula (1) to calculate the first confidence of the segment point between “ [symbol] ” and “ [symbol] ” based on each the first number of occurrences and the second number of occurrences.

$$log \frac{f ( a ) * f ( b )}{f ( a b )} \qquad ( 1 )$$

In formula (1), f(a) represents the number of occurrences of character a in the text collection to be segmented, that is, the first number of occurrences, and f(b) represents the number of occurrences of character b in the text collection to be segmented, that is, the first number of occurrences, f(ab) represents the number of occurrences that characters a and b occurs adjacently in the text collection to be segmented, that is, the second number of occurrences. Among them, a can be “ [symbol] ”, b can be “ [symbol] ”, and ab can be “ [symbol] ”. The calculation result of formula (1) is the first confidence.

It can be seen that in this embodiment, the first number of occurrences of each character of two adjacent characters in the preset text library, and the second number of occurrences of two adjacent characters occur adjacently in the preset text library can be used to calculate the first confidence of the segment point between two adjacent characters. The calculation process is simple and easy to implement.

In one embodiment, for two adjacent characters in the processed text, calculating the second confidence of the segment point, which does not exist between two adjacent characters, specifically includes:
(e1) Obtaining a first text by removing one of two adjacent characters from the processed text, and obtaining a second text by removing the other of the two adjacent characters from the processed text;
(e2) Calculating the second confidence of the segment point, which does not exist between two adjacent characters according to the processed text, the first text and the second text.

In step (e1), remove any one of the two adjacent characters from the processed text to obtain the first text, and remove the other of the two adjacent characters from the processed text to obtain the second text. In step (e2), based on the processed text, the first text and the second text, calculate the second confidence of the segment point, which does not exist between two adjacent characters.

In one embodiment, calculating the second confidence of the segment point, which does not exist between two adjacent characters according to the processed text, the first text and the second text, specifically includes:
(e21) Determining a first distance between the processed text and the first text, and determining a second distance between the processed text and the second text.
(e22) Determining an average value of the first distance and the second distance as the second confidence of the segment point, which does not exist between two adjacent characters.

What can be known is that the smaller the distance between the two texts is, the closer the semantics between the two texts is. Therefore, when the average of the first distance and the second distance is less than a certain threshold, it shows that removing any one of the two adjacent characters has little impact on the semantics of the processed text, so it can be determined that two adjacent characters are not a complete phrase, that is, there may be a segment point between two adjacent characters. On the contrary, when the average value of the first distance and the second distance is greater than or equal to the certain threshold, it means that removing any one of the two adjacent characters has a greater semantic impact on the processed text, so it can be determined that two adjacent characters are a complete phrase, that is, there is no segment point between two adjacent characters.

According to the above example, the processed text obtained is “ [symbol] ”. In this step, starting from “ [symbol] ”, calculate the second confidence of the segment point, which does not exist between “ [symbol] ” and “ [symbol] ”, the specific calculation process includes:

Remove “ [symbol] ” from the processed text, and get the first text “ [symbol] ”; remove “ [symbol] ” from the processed text, get the second text “ [symbol] ”. Calculate the first distance between the text “ [symbol] ” and the first text “ [symbol] ”, calculate the second distance between the text “ [symbol] ” and the second text “ [symbol] ”, take the average value of the first distance and the second distance as the second confidence of the segment point, which does not exist between “ [symbol] ” and “ [symbol] ”.

The first distance and the second distance may be an Euclidean distance, a cosine distance, etc. Before calculating the first distance and the second distance, the first text, the second text and the processed text need to be vectorized respectively. The vectorization methods include but are not limited to TF-IDF, word2vec, glove, ELMo, BERT, etc.

According to the processed text, the first text and the second text, the process of calculating the second confidence of the segment point, which does not exist between two adjacent characters can be expressed by the following formula (2).

$$\frac{d ( text\_vec , text\_a \_vec ) + d ( text\_vec , text\_b \_vec )}{2} \qquad ( 2 )$$

Among them, text_vec represents a vector of the processed text, text_a_vec represents a vector of the first text, and text_b_vec represents a vector of the second text. d(text_vec, text_a_vec) represents a first vector distance between the processed text and the first text; d(text_vec, text_b_vec) represents a second vector distance between the processed text and the second text, i.e., the second distance.

It can be seen that in this embodiment, the first text and the second text can be obtained by removing the character from the processed text. According to the first distance between the processed text and the first text and the second distance between the processed text and the second text, determine the second confidence of the segment point, which does not exist between two adjacent characters. The calculation process is simple and easy to implement.

In a specific embodiment, according to the above example, the processed text obtained is “ [symbol] ”. In step S104, the computer device first calculates the first confidence of the segment point between “ [symbol] ” and “ [symbol] ”, through the above steps (d1) and (d2). In response that the first confidence is less than or equal to the first preset threshold, the computer device determines that there is no segment point between “ [symbol] ” and “ [symbol] ”. In response that the first confidence is greater than the first preset threshold, the computer device calculates the second confidence of the segment point, which does not exist between “ [symbol] ” and “ [symbol] ” through the above steps (e1) and (e2). In response that the second confidence is less than the second preset threshold, the computer device determines that there is the segment point between “ [symbol] ” and “ [symbol] ”. In response that the second confidence is greater than or equal to the second preset threshold, the computer device determines that there is no segment point between “ [symbol] ” and “ [symbol] ”.

Through the above process, in step S104, whether there is the segment point between two adjacent characters is determined, so that the position of the segment point is determined and recorded in the processed text.

In step S106, the text is segmented based on the position of the segment point that is determined. It should be noted that the determined position of the segment point used in step S106 includes the position of the segment point determined in step S104, and also includes the position of the segment point recorded during the preprocessing process in step S102. In addition, the position before the first character and the position after the last character in the text can also be recorded as positions of segment points.

In a specific example, the text is “ [symbol] ” After inserting the position symbols, it is “0 [symbol] 1 [symbol] 2 [symbol] 3 [symbol] 4 [symbol] 5 [symbol] 6 [symbol] 7”.Through step S102, it is determined that the character “ [symbol] ” is obtained, and the positions of segment points “5 and 7” are recorded, and the positions of segment points 5 and 7 are recorded as the positions of the determined character.

Next, through step S104, the text is segmented according to positions 5 and 7, and a sub-text “0 [symbol] 1 [symbol] 2 [symbol] 3 [symbol] 4 [symbol] 5” is obtained. Within the sub-text, start traversing from the starting position 0 and obtain “ [symbol] ”, and calculate the first confidence of the segment point between “ [symbol] ” and “ [symbol] ” and the second confidence of the segment point, which does not exist between “ [symbol] ” and “ [symbol] ”. Then determine that there is no segment point between “ [symbol] ” and “ [symbol] ”, then traverse to “ [symbol] [symbol] ”, and calculate the first confidence of the segment point between “ [symbol] ” and “ [symbol] ” and the second confidence of the segment point, which does not exist between “ [symbol] ” and “ [symbol] ”, and then determine that there is a segment point between “ [symbol] ” and “ [symbol] ”, and recording a position 2 of a segment point, and then continue to traverse from position 2, and “ [symbol] ” is traversed, and calculate the first confidence of the segment point between “ [symbol] ” and “ [symbol] ” and the second confidence of the segment point, which does not exist between “ [symbol] ” and “ [symbol] ”, determine that there is a segment point between “ [symbol] ” and “ [symbol] ”, and then record the position 3 of a segment point. Then, continue traversing from position 3 to “ [symbol] ”, and calculate the first confidence of the segment point between “ [symbol] ” and “ [symbol] ” and the second confidence of the segment point, which does not exist between “ [symbol] ” and “ [symbol] ”, determine that there is a segment point between “ [symbol] ” and “ [symbol] ”, and then record the position 4 of the segment point, and then, traverse from position 4 to position 5, confirming the end of the traversal, and finally obtaining the positions “2, 3, 4” of segment points.

Furthermore, the position “0” before the first character and the position “7” after the last character in the text are recorded as positions of segment points.

It can be seen that the position of the segment point has three different sources, and among these three sources, there are overlapping positions, such as the above-mentioned position 7. The recorded position of the segment point can also be deduplicated to obtain the final positions 0, 2, 3, 4, 5, and 7 of segment points.

In another embodiment, in step S104, when performing the segment position identification and recording the positions of segment points of the sub-text “0 [symbol] 1 [symbol] 2 [symbol] 3 [symbol] 4 [symbol] 5”, when traversing to position 2 and determining that there is the segment point, the positions of segment points can be recorded as 0 and 2. When traversing to position 3 and determining the existence of the segment point, positions 2 and 3 of segment points can be recorded. That is, when the segment point is traversed, both the traversal starting position and the segment point will be recorded, and thus obtain a plurality of positions of segment points as 0, 2, 2, 3, 3, 4, 4, and 5. Based on this, remove duplicates from the plurality of positions of segment points that have been obtained and obtain positions 0, 2, 3, 4, and 5 of segment points. The positions of segment points obtained here are merged with the positions of segment points obtained in step S102 and the first and last positions of the text to obtain the final positions of segment points.

In the above step S106, the text is segmented at the recorded positions of segment points. Specifically, a delimiter is inserted at the position of the segment point that is recorded so as to segment the text. For example, the word segmentation result is obtained:

[symbol]

In this embodiment, any symbol of the segment point can be used to segment the text. There is no need to calculate complex parameters during the segmentation process. The implementation is simple and the segmentation efficiency is high.

To sum up, the embodiments of the text segmentation method provided above have at least the following technical effects:
(1) There is no need to calculate complex parameters such as the left branch entropy and the right branch entropy, the accessor variety, etc., which can improve word segmentation efficiency.
(2) There is no limit on the length of the phrase after segmentation, and phrases of any length can be obtained by segmentation.
(3) By calculating the first confidence of the segment point between two adjacent characters and the second confidence of the segment point, which does not exist between two adjacent characters in different ways, the accuracy of determining the segment point can be improved, thereby improving the accuracy of word segmentation.
(4) This text segmentation method is highly transferable and versatile, and can be applied to various scenarios. For example, it is applied to the field of new word recognition, and new words are discovered by counting word frequencies based on word segmentation.

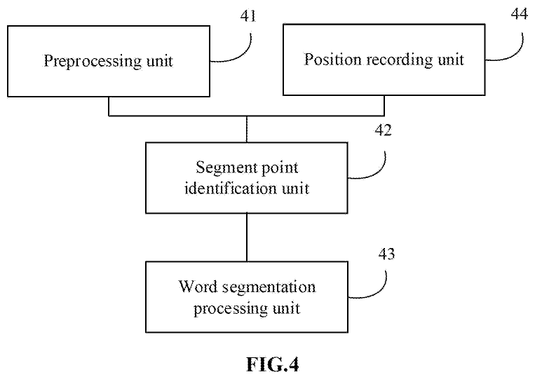

FIG. 4 is a schematic structural diagram of a text segmentation device provided by an embodiment of the present application. As shown in FIG. 4, the device includes:

A preprocessing unit 41 is used to obtain a text to be segmented, preprocess the text, and obtain a processed text.

A segment point identification unit 42 is used to calculate a confidence of a segment point between two adjacent characters in the processed text, and determine a position of the segment point in the processed text based on the confidence.

A word segmentation processing unit 43 is used to segment the text according to the position.

Optionally, the segment point identification unit 42 is specifically configured to calculate a first confidence of the segment point between two adjacent characters in the processed text. Optionally, the segment point identification unit 42 is specifically configured to calculate a second confidence of the segment point, which does not exist between two adjacent characters in the processed text.

Optionally, the segment point identification unit 42 is specifically configured to calculate the first confidence of the segment point between two adjacent characters in the processed text; and calculate the second confidence of the segment point, which does not exist between two adjacent characters in the processed text.

Optionally, the preprocessing unit 41 is specifically used to: match a pre-established stopword list with the text to determine a character that is in both of the text and the stopword list, determine the position of the segment point in the text according to the determined character, and determine the text as the processed text after the position of the segment point has been determined.

Optionally, a position recording unit 44 is also included, which is used to: record the position of the determined character in the text after obtaining the processed text, so as to skip the determined character when determining the position of the segment point.

Optionally, the segment point identification unit 42 is specifically configured to: determining a starting position of the processed text as a traversal starting position and executing a first traversal process.

If the position of the segment point is determined, determining the position of the segment point as the traversal starting position and repeating the first traversal process, if the recorded position is traversed, traversing from the traversed position until a next recorded position is traversed, and determining the next recorded position as the traversal starting position and repeating the first traversal process.

Optionally, the first traversal process includes: traversing every two adjacent characters from the traversal starting position, calculating the first confidence of the segment point between each two adjacent characters that have been traversed, and/or calculating the second confidence of the segment point, which does not exist between every two adjacent characters that have been traversed, determining whether there is the segment point between every two adjacent characters that have been traversed according to the calculation result, until the position of the segment point is determined or the recorded position is traversed, or the ending position of the processed text is traversed.

Optionally, the segment point identification unit 42 is specifically used to:

Segmenting the processed text according to the starting position, the ending position and the recorded position of the processed text, and determining a plurality of sub-texts;

For each sub-text, determining the starting position of the sub-text as a traversal starting position and perform a second traversal process;

If the position of the segment point is determined, determining the position of the segment point as the traversal starting position and repeat the second traversal process.

Optionally, the second traversal process includes: traversing every two adjacent characters from the traversal starting position, and calculating the first confidence of the segment point between every two adjacent characters that have been traversed, and/or, calculating the second confidence of the segment point, which does not exist between every two adjacent characters that have been traversed, determining whether there is the segment point between each two adjacent characters that have been traversed according to the calculation result, until the position of the segment point is identified or the ending position of the sub-text is traversed.

Optionally, the segment point identification unit 42 is specifically used to:

In the processed text, calculate the first confidence of the segment point between two adjacent characters; if the first confidence is less than or equal to a first preset threshold, determine that there is no segment point between the two adjacent characters; if the first confidence is greater than the first preset threshold, then calculate the second confidence of the segment point, which does not exist between the two adjacent characters; if the second confidence is less than a second preset threshold, then it is determined that there is the segment point between the two adjacent characters, if the second confidence is greater than or equal to the second preset threshold, then it is determined that there is no segment point between the two adjacent characters;

Or,

In the processed text, calculate the second confidence of the segment point, which does not exist between two adjacent characters; if the second confidence is greater than or equal to the second preset threshold, determine that there is no segment point between two adjacent characters. If the second confidence is less than the second preset threshold, then the first confidence of the segment point between two adjacent characters is calculated; if the first confidence is greater than the second preset threshold, it is determined that there is a segment point between two adjacent characters. If the first confidence is less than or equal to the first preset threshold, it is determined that there is no segment point between two adjacent characters.

Optionally, the segment point identification unit 42 is also specifically used to:

Obtain a first number of occurrences of each of the two adjacent characters occurs in a preset text library, and obtain a second number of occurrences of the two adjacent characters occur adjacently in the preset text library;

Calculate the first confidence of the segment point between two adjacent characters based on the first number of occurrences corresponding to each character of the two adjacent characters and the second number of occurrences.

Optionally, the segment point identification unit 42 is also specifically used to:

Obtain a first text by removing one of two adjacent characters from the processed text, and obtain a second text by removing the other of the two adjacent characters from the processed text;

Calculate the second confidence of the segment point, which does not exist between two adjacent characters according to the processed text, the first text and the second text.

Optionally, the segment point identification unit 42 is also specifically used to:

Obtain a product by multiplying the first number of occurrences corresponding to each character of two adjacent characters, and calculate a ratio of the product to the second number of occurrences;

Determine the first confidence of the segment point between two adjacent characters based on the ratio.

Optionally, the segment point identification unit 42 is also specifically used to:

Determine a first distance between the processed text and the first text, and determine a second distance between the processed text and the second text;

Determine an average value of the first distance and the second distance as the second confidence of the segment point, which does not exist between two adjacent characters.

It should be noted that the text segmentation device in this embodiment can implement each process of the afore-mentioned text segmentation method embodiment and achieve the same effects and functions, which will not be repeated here.

An embodiment of the present application also provides a computer device. The computer device may specifically used to perform the text segmentation method. FIG. 5 is a schematic structural diagram of the computer device provided by an embodiment of the present application, as shown in FIG. 5, the computer device may vary greatly due to different configurations or performance, and may include one or more processors 1001 and storage device 1002, and the storage device 1002 may store one or more storage application programs or data. Among them, the storage device 1002 can be a temporary storage or a persistent storage. The application program stored in the storage device 1002 may include one or more modules (not shown), and each module may include a series of computer-executable instructions on the computer device. Furthermore, the processor 1001 may be configured to communicate with the storage device 1002 and execute a series of computer-executable instructions in the storage device 1002 on the computer device. The computer device may also include one or more power supplies 1003, one or more wired or wireless network interfaces 1004, one or more input/output interfaces 1005, one or more keyboards 1006, etc.

In a specific embodiment, the computer device includes: a processor; and a storage device arranged to store computer-executable instructions, the computer-executable instructions being configured to be executed by the processor to implement the following process:

Obtaining a text to be segmented, preprocessing the text and determining a processed text;

Performing a segment position identification in the processed text; the segment position identification includes:

Calculating a confidence of a segment point between two adjacent characters in the processed text, and determining a position of the segment point in the processed text based on the confidence;

Segmenting the text according to the position.

It should be noted that the computer device in this embodiment can implement each process of the embodiment of the afore-mentioned text segmentation method and achieve the same effects and functions, which will not be repeated here.

An embodiment of the present application also provides a storage medium for storing computer-executable instructions.

In a specific embodiment, the storage medium can be a USB disk, an optical disk, a hard disk, etc. When the computer-executable instructions stored in the storage medium are executed by the processor, the following process can be implemented:

Obtaining a text to be segmented, preprocessing the text and determining a processed text;

Performing a segment position identification in the processed text; the segment position identification includes:

Calculating a confidence of a segment point between two adjacent characters in the processed text, and determining a position of the segment point in the processed text based on the confidence;

Segmenting the text according to the position.

It should be noted that the storage medium in this embodiment can implement each process of the embodiment of the aforementioned text segmentation method and achieve the same effects and functions, which will not be repeated here.

The above has described specific embodiments of the present application. Other embodiments are within the scope of the appended claims. In some cases, the actions or steps recited in the claims can be performed in a different order than in the embodiments and still achieve desired results. Additionally, the processes depicted in the figures do not necessarily require the specific order shown, or the sequential order that are shown, to achieve desirable results. Multitasking and parallel processing are also possible or may be advantageous in certain implementations.

Those skilled in the art should understand that embodiments of the present application may be provided as methods, systems or computer program products. Therefore, embodiments of the present application may take the form of an entirely hardware embodiment, an entirely software embodiment, or an embodiment that combines software and hardware aspects. Furthermore, the present application may take the form of a computer program product embodied on one or more computer-readable storage medium (including, but not limited to, disk storage, CD-ROM, optical storage, etc.) embodying computer-usable program code therein.

The present application is described with reference to flowchart illustrations and/or block diagrams of methods, apparatus (systems), and computer program products according to embodiments of the application. It will be understood that each process and/or block in the flowchart illustrations and/or block diagrams, and combinations of processes and/or blocks in the flowchart illustrations and/or block diagrams, can be implemented by computer program instructions. These computer program instructions may be provided to a processor of a general purpose computer, a special purpose computer, an embedded processor, or other programmable data processing device to produce a machine, such that the instructions executed by the processor of the computer or other programmable data processing device produce a device for realizing the functions specified in a process or processes in a flowchart and/or a block or blocks in a block diagram.

These computer program instructions may also be stored in a computer-readable storage device that causes a computer or other programmable data processing device to operate in a particular manner, such that the instructions stored in the computer-readable storage device produce an article of manufacture including the instruction means, the instructions The device implements the functions specified in a process or processes in the flowchart and/or in a block or blocks in the block diagram.

These computer program instructions may also be loaded onto a computer or other programmable data processing device, causing a series of operating steps to be performed on the computer or other programmable device to produce computer-implemented processing, thereby executing on the computer or other programmable device. Instructions provide steps for implementing the functions specified in a process or processes of a flowchart diagram and/or a block or blocks of a block diagram.

In a typical configuration, the computing device includes one or more processors (Central Processing Unit, CPU), input/output interfaces, network interfaces, and memory.

Memory may include non-permanent storage of computer-readable medium, random access memory (RAM), and/or non-volatile memory, such as read-only memory (ROM) or flash memory (flash RAM). Memory is an example of computer-readable medium.

The computer-readable medium includes both persistent and non-volatile, removable and non-removable media that can be implemented by any method or technology for storage of information. The information may be computer-readable instructions, data structures, modules of programs, or other data. Examples of computer storage medium include, but are not limited to, phase-change RAM (PRAM), static random access memory (Static RAM, SRAM), dynamic random access memory (Dynamic RAM, DRAM), other types random access memory (RAM), read-only memory (ROM), electrically erasable programmable ROM (EEPROM), flash memory or other memory technology, compact disc read-only memory (CD-ROM), digital versatile disc (DVD) or other optical storage, magnetic tape cassettes, magnetic disk storage or other magnetic storage devices, or any other non-transmission medium that may be used to store information that can be accessed by a computing device. As defined in this article, computer-readable medium does not include transitory media, such as modulated data signals and carrier waves.

It should also be noted that the terms “comprising,” “comprises,” or any other variation thereof are intended to cover a non-exclusive inclusion, such that a process, a method, an article, or a device that includes a list of elements not only includes those elements, but also includes other elements are not expressly listed or are inherent to the process, method, article or device. Without further limitation, an element defined by the statement “comprises a . . . ” does not exclude the presence of additional identical elements in the process, method, article, or device that includes the elements.

Embodiments of the present application may be described in the general context of computer-executable instructions, such as program modules, being executed by a computer. Generally, program modules include routines, programs, objects, components, data structures, etc. that perform specific tasks or implement specific abstract data types. One or more embodiments of the present application may also be practiced in distributed computing environments where tasks are performed by remote processing devices connected through a communications network. In this distributed computing environment, program modules may be in both local and remote computer storage medium including storage devices.

Each embodiment in this application is described in a progressive manner. The same and similar parts between the various embodiments can be referred to each other. Each embodiment focuses on its differences from other embodiments. In particular, for the system embodiment, since it is basically similar to the method embodiment, the description is relatively simple. For relevant details, please refer to the partial description of the method embodiment.

The above are only examples of this document and are not intended to limit this document. Various modifications and variations of this document may occur to those skilled in the art. Any modifications, equivalent replacements, improvements, etc. made within the spirit and principles of this document shall be included in the scope of the claims of this document.

What is claimed is:

1. A text segmentation method, comprising:
obtaining a text to be segmented, preprocessing the text and determining a processed text;
calculating a confidence of a segment point between two adjacent characters in the processed text, and determining a position of the segment point in the processed text based on the confidence; and
segmenting the text according to the position.

2. The text segmentation method according to claim 1, wherein calculating the confidence of the segment point between two adjacent characters in the processed text, comprises:
calculating a first confidence of the segment point between two adjacent characters in the processed text.

3. The text segmentation method according to claim 1, wherein calculating the confidence of the segment point between two adjacent characters in the processed text, comprises:
calculating a second confidence of the segment point, which does not exist between two adjacent characters in the processed text.

4. The text segmentation method according to claim 1, wherein calculating the confidence of the segment point between two adjacent characters in the processed text, comprises:
calculating a first confidence of the segment point between two adjacent characters in the processed text; and
in response that the first confidence is greater than a first preset threshold, calculating a second confidence of the segment point, which does not exist between two adjacent characters in the processed text.

5. The text segmentation method according to claim 1, wherein preprocessing the text and determining the processed text comprises:
matching a pre-established stopword list with the text and determining a character that is in both of the text and the pre-established stopword list;
determining the position of the segment point in the text according to the determined character, and determining the text as the processed text after the position of the segment point has been determined.

6. The text segmentation method according to claim 5, wherein after determining the processed text, the method further comprises:
recording a position of the determined character in the processed text.

7. The text segmentation method according to claim 6, wherein calculating the confidence of the segment point between two adjacent characters in the processed text, and determining the position of the segment point in the processed text based on the confidence, comprises:
determining a starting position of the processed text as a traversal starting position and executing a first traversal process;
in response that the position of the segment point is determined, determining the position of the segment point as the traversal starting position and repeating the first traversal process until the processed text is executed;
in response that a recorded position is traversed, traversing from the recorded position that is traversed until a next recorded position is traversed, and determining the next recorded position as the traversal starting position and repeating the first traversal process until the processed text has been executed.

8. The text segmentation method according to claim 7, wherein the first traversal process comprises: traversing every two adjacent characters from the traversal starting position, calculating a first confidence of the segment point between each two adjacent characters that have been traversed, and/or calculating a second confidence of the segment point, which does not exist between every two adjacent characters that have been traversed, determining whether there is the segment point between every two adjacent characters that have been traversed according to a calculation result, until the position of the segment point is determined or the recorded position is traversed, or an ending position of the processed text is traversed.

9. The text segmentation method according to claim 7, wherein calculating the confidence of the segment point between two adjacent characters in the processed text, and determining the position of the segment point in the processed text based on the confidence, comprises:
segmenting the processed text according to the starting position, the ending position and the recorded position of the processed text, and determining a plurality of sub-texts;
determining the starting position of the sub-text as the traversal starting position and perform a second traversal process;
in response that the position of the segment point is determined, determining the position of the segment point as the traversal starting position and repeating the second traversal process until the sub-text has been traversed.

10. The text segmentation method according to claim 9, wherein the second traversal process comprises: traversing every two adjacent characters from the traversal starting position, calculating a first confidence of the segment point between every two adjacent characters that have been traversed, and/or, calculating a second confidence of the segment point, which does not exist between every two adjacent characters that have been traversed, determining whether there is the segment point between each two adjacent characters that have been traversed according to a calculation result, until the position of the segment point is determined or the ending position of the sub-text is traversed.

11. The text segmentation method according to claim 1, wherein calculating the confidence of the segment point between two adjacent characters in the processed text, and determining the position of the segment point in the processed text based on the confidence, comprises:
calculating a first confidence of the segment point between two adjacent characters; in response that the first confidence is less than or equal to a first preset threshold, determining that there is no segment point between the two adjacent characters; in response that the first confidence is greater than the first preset threshold, calculating a second confidence of the segment point, which does not exist between the two adjacent characters; in response that the second confidence is less than a second preset threshold, determining that there is the segment point between the two adjacent characters, in response that the second confidence is greater than or equal to the second preset threshold, determining that there is no segment point between the two adjacent characters;
or,
in the processed text, calculating the second confidence of the segment point, which does not exist between two adjacent characters; in response that the second confidence is greater than or equal to the second preset threshold, determining that there is no segment point between two adjacent characters, in response that the second confidence is less than the second preset threshold, calculating the first confidence of the segment point between two adjacent characters; in response that the first confidence is greater than the first preset threshold, determining that there is the segment point between two adjacent characters, in response that the first confidence is less than or equal to the first preset threshold, determining that there is no segment point between two adjacent characters.

12. The text segmentation method according to claim 2, wherein calculating the first confidence of the segment point between two adjacent characters in the processed text, comprises:
obtaining a first number of occurrences of each of the two adjacent characters occurs in a preset text library, and obtaining a second number of occurrences of the two adjacent characters occur adjacently in the preset text library;
calculating the first confidence of the segment point between two adjacent characters based on the first number of occurrences corresponding to each character of the two adjacent characters and the second number of occurrences.

13. The text segmentation method according to claim 12, wherein calculating the first confidence of the segment point between two adjacent characters based on the first number of occurrences corresponding to each character of the two adjacent characters and the second number of occurrences, comprises:
obtaining a product by multiplying the first number of occurrences corresponding to each character of the two adjacent characters, and calculating a ratio of the product to the second number of occurrences; and
determining the first confidence of the segment point between two adjacent characters based on the ratio.

14. The text segmentation method according to claim 3, wherein calculating the second confidence of the segment point, which does not exist between two adjacent characters in the processed text, comprises:
obtaining a first text by removing one of two adjacent characters from the processed text, and obtaining a second text by removing the other of the two adjacent characters from the processed text;
calculating the second confidence of the segment point, which does not exist between two adjacent characters according to the processed text, the first text and the second text.

15. The text segmentation method according to claim 14, wherein calculating the second confidence of the segment point, which does not exist between two adjacent characters according to the processed text, the first text and the second text, comprises:
determining a first distance between the processed text and the first text, and determining a second distance between the processed text and the second text; and
determining an average value of the first distance and the second distance as the second confidence of the segment point, which does not exist between two adjacent characters.

16. A computer device, comprising:
a processor; and
a storage device storing computer-executable instructions, which when executed by the processor, cause the processor to:
obtain a text to be segmented, preprocess the text and determine a processed text;
calculate a confidence of a segment point between two adjacent characters in the processed text, and determine a position of the segment point in the processed text based on the confidence; and
segment the text according to the position.

17. The computer device according to claim 16, wherein the processor calculates the confidence of the segment point between two adjacent characters in the processed text by:
calculating a first confidence of the segment point between two adjacent characters in the processed text.

18. The computer device according to claim 16, wherein the processor calculates the confidence of the segment point between two adjacent characters in the processed text by:
calculating a second confidence of the segment point, which does not exist between two adjacent characters in the processed text.

19. A non-transitory storage medium being stored computer-executable instructions thereon, when the computer-executable instructions are executed by a processor of a computer device, the processor is caused to perform a text segmentation method, wherein the method comprises:
obtaining a text to be segmented, preprocessing the text and determining a processed text;
calculating a confidence of a segment point between two adjacent characters in the processed text, and determining a position of the segment point in the processed text based on the confidence; and
segmenting the text according to the position.

20. The non-transitory storage medium according to claim 19, wherein calculating the confidence of the segment point between two adjacent characters in the processed text, comprises:
calculating a first confidence of the segment point between two adjacent characters in the processed text.
